(19) United States
(12) Patent Application Publication
(10) Pub. No.: US 2010/0233392 A1
(43) Pub. Date: Sep. 16, 2010

(54) DISPERSION OF ALUMINIUM OXIDE, COATING COMPOSITION AND INK-ABSORBING MEDIUM

(75) Inventors: Christoph Batz-Sohn, Hanau-Mittelbuchen (DE); Wolfgang Lortz, Waechtersbach (DE); Arnold Storeck, Frankfurt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GMBH, ESSEN (DE)

(21) Appl. No.: 12/305,748

(22) PCT Filed: Jul. 4, 2007
(86) PCT No.: PCT/EP07/56726

§ 371 Date: Dec. 19, 2008

(30) Foreign Application Priority Data
Aug. 22, 2006 (DE) 10 2006 039 269.8

(51) Int. Cl. B41M 5/00; C08K 3/22; B05D 5/06; C09D 7/12

(52) U.S. Cl. 428/32.34; 524/430; 427/162; 106/287.17

(57) ABSTRACT

Dispersion of aluminium oxide, characterised in that it contains 20 to 60 wt.-% of pyrogenically-produced aluminium oxide powder in form of aggregates of primary particles, wherein the powder has - a BET specific surface area of from 50 to 150 m²/g—a ratio Sears number/BET surface area which is from about 0.150 to 0.160, wherein the mean aggregate diameter in the dispersion is less than 200 nm.

The invention relates to a dispersion of pyrogenically-produced aluminium oxide, a process for its production and its use. It also relates to coating composition and an ink-absorbing medium.

In pigment-rich coatings, ink is absorbed into a porous pigment network. Amorphous silica is nowadays the most common pigment type in such systems because of its large absorption capacity and hydrophilic nature. The considerable absorbency of silica coating is based on its large specific surface area, which originates from the presence of both inter- and intra-particle pores. The former transport the carrier phase rapidly away from the surface of the coating, whereas the latter cause the eventual ink absorption because of the strong capillary pressure prevailing in narrow pores. Moreover, silica particles are able to interact with the inks, owing to the reactive silanol groups and hydrated water on their surfaces. Indeed, silica has been shown to absorb ink solvents selectively in relation to the colorants, which results in partitioning of the colorant in the vicinity of the coating surface. Several silica grades are currently available, namely fumed, colloidal, precipitated, and gel types. Their particle sizes typically range from less than 100 nm to greater than 1 μm. Colloidal, precipitated and fumed silica are composed of nonporous primary particles, whereas silica gel exists as rigid and porous three-dimensional networks, with a particle size down to 300 nm.

In addition to the silica pigment, alumina is also used in ink jet coatings, especially in high-performance glossy coatings. Pseudoboehmite is a special type of commercial alumina, which is generally used as an aqueous dispersion. Furthermore, mixed oxides of silicon and aluminum can also be applied to ink jet coatings.

The coating polymer system selected for pigment-rich coatings is generally very important for the ultimate print quality, because the polymers immobilize the pigment particles and attach them to the base paper, and also absorb the carrier phase of the ink. With aqueous ink jet inks, the drying of the print on coated paper is therefore generally markedly dependent on the water absorption capacity of the binder. This can be influenced by choosing a polymer of suitable chemical nature and molecular weight.

The most common binders in pigment-rich ink jet coatings are water-soluble hydrophilic polymers, such as polyvinyl alcohol (PVA), polyvinyl pyrrolidone (PVP), and polyvinyl acetate (PVAc) 2002). Pre-eminently partially hydrolyzed, relatively low-molecular weight PVA grades have proven to be effective binders when combined with silica pigment.

Moreover, owing to its non-ionic nature, PVA can be used together with most additives of coating colors, including cationic polymers and surface sizes.

Besides rapid ink absorption, cationic water-soluble polymers, like PVP, offer high print density because of their capability to interact with both water and solvent. For this reason, cationic polymers are commonly included as mordants in ink jet coatings. For example, polydiallyl dimethylammonium chloride (poly-DADMAC) and cationic PVA are known to improve dye attachment in addition to PVP. When used in combination with silica, the added amount is usually relatively low because of the drastic impact of cationic polymers on coating color rheology. Other binder types that have been applied to ink jet coatings are aqueous emulsions of styrene acrylic and styrene butadiene latexes, as well as special binders like gelatin and its derivatives.

In silica coatings, the solids content is typically less than 20%, which makes high-speed coating quite complicated. In addition, considerable amounts of binders, often more than 40 wt % are needed. Silica papers also typically exhibit poor printability in other printing processes, which may restrict their applicability to hybrid printing processes involving a combination of conventional and ink jet printing techniques.

In addition to the silica pigment, alumina is also used in ink jet coatings, especially in high-performance glossy coatings. Pseudoboehmite is a special type of commercial alumina, which is generally used as an aqueous dispersion. Also fumed alumina can be used for ink jet coatings.

There is however still the need to improve the quality of ink-jet substrates. This in particular depends on the nature of the dispersion used to produce the ink jet coating.

The object of the invention is therefore to provide a stable dispersion of metal oxide particles. A further object of the invention is to provide, on the basis of this dispersion, a coating composition for an ink-absorbing medium, with high gloss and high colour-density.

The invention provides a dispersion, which is characterised in that it contains 20 to 60 wt % of pyrogenically-produced aluminium oxide powder in form of aggregates of primary particles, wherein the powder has
a BET specific surface area of from 50 to 150 m²/g
a ratio Sears number/BET surface area which is from about 0.150 to 0.160,
wherein the mean aggregate diameter in the dispersion is less than 200 nm, preferably 110 to 160 nm.

The pyrogenically-produced aluminium oxide that can be used according to the invention, can be produced by the flame oxidation, or preferably flame hydrolysis, method, an evaporable aluminium compound, preferably the chloride, being used as the starting material.

The alumina used in the dispersion according to the invention can be varied over a wide range of BET surface area. Typical values are 65±10 m²/g, 100±10 m²/g and 130±10 m²/g.

The particles are in form of aggregates of primary particles. Primary particles do not exist as discrete entities. Due to their loose aggregation they do not have internal surface area resulting from pores but have only external surface area. Specific surface area is a function of primary particle size.

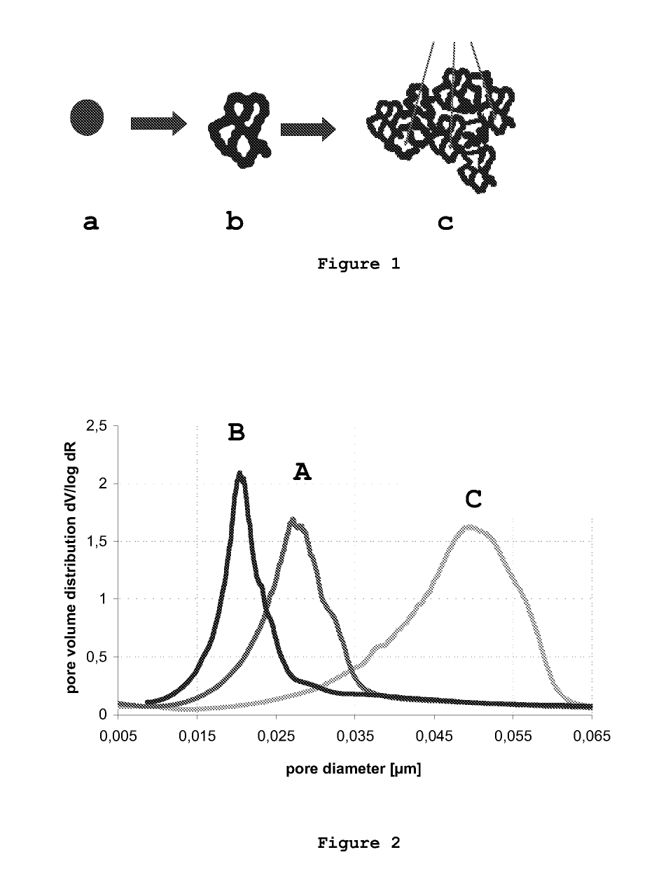

Although not porous as such, the alumina particles according to the invention form pores because there is space left in between every single primary particle. This space forms interaggregate pores (FIG. 1; a=primary particle; b=aggregate; c=pigment in coating layer; arrows indicating pores).

These pores are needed to create absorption capacity. The solvent of the inkjet ink must be absorbed within the coating layer. In general this solvent is water. In case of RC paper, hence polyolefin layer or a film, there is a complete lack of absorption capacity. But even for inkjet coating on paper there is absorption capacity needed in the coating layer in order to secure a fast print drying. Mercury porosity has proven to be a good means to measure the pore volume of a coated inkjet sheet.

FIGURE shows the interaggregete pore size distribution of the alumina powder 1(A), alumina powder 2(B) and alumina powder 3(C).

The dispersion according to the invention may also contain, in addition to aluminium oxide, inorganic acids (such as hydrochloric acid, nitric acid, sulfuric acid), organic acids (such as formic acid, acetic acid, propionic acid), inorganic bases (such as potassium hydroxide, sodium hydroxide, ammonium hydroxide) or organic bases (such as amines, tetraalkylammoniumhydroxides), salts (such as sodium chloride, potassium formate, calcium nitrate), buffer systems (such as potassium dihydrogen phosphate/phosphoric acid buffer, acetic acid/sodium acetate buffer) ionic, or non-ionic surfactants, polyelectrolytes, polymers and/or biocides.

The invention further provides a process for the production of the dispersion according to the invention, which is characterised in that pyrogenically-produced aluminium oxide in form of aggregates of primary particles having a BET specific surface area of from 50 to 150 m²/g is mixed with water, a pH value of 2 to 11, preferably 3 to 5, is set and the mixture is dispersed by the introduction of shearing forces.

To disperse the pyrogenically-produced aluminium oxide, shearing equipment such as rotor-stator-type machines (batch- or continuous in-line machines), ball mills, pearl mills, agitated ball mills or high-pressure homogenisers can be used. The operating mode of a high-pressure homogeniser is characterized in that two pre-dispersed suspension streams under high pressure are released through a nozzle. The two dispersion jets collide with each other exactly and the particles mill themselves. In another embodiment the pre-dispersion is also placed under high pressure, but the particles collide against armoured areas of wall. The operation can be repeated as often as desired to obtain smaller particle sizes.

The advantages of the dispersion according to the invention are:
A high cationic charge on the surface of the particles.
The particle size distribution of the dispersion can be set in a defined way.
The dispersion purity is high.
The electrolyte level within the dispersion can be precisely controlled.
There is a highly distinctive “structure/crosslinking” of the aluminium oxide primary particles within the dispersion.
The alumina particles in the dispersion provide a high degree of hardness and abrasion resistance.

The invention further provides a coating composition for the formation of the ink-absorbing layer, which contains the dispersion according to the invention and at least one binder.

The following may be used as binders: polyvinyl alcohol, partially- or fully-saponified, and cationised polyvinyl alcohol containing a primary, secondary or tertiary amino group or a tertiary ammonium group on the main chain or the side chain. Also combinations of these polyvinyl alcohols with each other and polyvinylpyrrolidones, polyvinylacetates, silanised polyvinyl alcohols, styrene-acrylate-lattices, styrene-butadiene-lattices, melamine resins, ethylene-vinylacetate-copolymers, polyurethane resins, synthetic resins such as polymethyl methacrylates, polyester resins (e.g. unsaturated polyester resins), polyacrylates, modified starch, casein, gelatines and/or cellulose derivatives (e.g. carboxymethylcellulose). Polyvinyl alcohol or cationised polyvinyl alcohols are preferred.

The coating composition may also contain one or more other pigments such as calcium carbonate, layered silicates, aluminium silicates, plastic pigments (e.g. polystyrene, polyethylene, polypropylene), silicas (e.g. colloidal silicas, precipitated silicas, silica gels, cationised variants of the stated silica compounds, aluminium compounds (for example aluminium sols, colloidal aluminium oxides and their hydroxy compounds, such as pseudo-boehmite, boehmite, aluminium hydroxide), magnesium oxide, zinc oxide, zirconium oxide, magnesium carbonate, kaolin, clay, talc, calcium sulfate, zinc carbonate, satin white, lithopones and zeolites.

The coating composition may have an alumina content of 10 to 50 wt.-%. It is preferably greater than 15 wt.-%.

The coating composition may further contain a proportion of binders in relation to the alumina particles, which is 3 to 150 wt.%, preferably 10 to 40 wt.% and in particular 3 to 15 wt.%.

To increase the water-resistance of the binder system and thus the coating, crosslinkers may be used, such as boric acid, melamine resins, glyoxal and isocyanates and other molecules that bind the molecule chains of the binder system with each other.

Furthermore, auxiliary agents such as optical brighteners, de-foaming agents, wetting agents, pH buffers, UV absorbers and viscosity improvers can also be used.

The invention further provides the production of a coating composition, which is characterised in that the dispersion according to the invention is added, whilst stirring, to an aqueous solution of the hydrophilic binder, to which other additives may optionally be added, and optionally diluted, until the desired ratio of alumina particles to binder and the desired total solids content is obtained. The order of addition is not important. The mixture is optionally stirred for a certain time and if necessary de-aerated in a vacuum. Additives are understood to mean, for example, pigment, crosslinkers, optical brighteners, de-foamers, wetting agents, pH buffers, UV absorbers and viscosity improvers.

The invention further provides an ink-absorbing layer that uses the coating composition according to the invention and a carrier. The carrier may be, for example, paper, coated paper, resin films, such as a polyester resin, including polyethylene terephthalate, polyethylene naphthalate, a diacetate resin, a triacetate resin, an acrylic resin, a polycarbonate resin, a polyvinyl chloride, a polyimide resin, cellophane, celluloid or a glass plate.

Photographic base papers, i.e. papers to the front and back of which one or more layers of polyethylene film have been applied, are preferred. Also polyester film, PVC film or pre-coated papers.

The ink-absorbing medium according to the invention also includes media in which the ink-absorbing layer consists of several coating layers of the same type or other layers. The coating composition according to the invention may only be found in one or more layers. Thus, for example, other ink-absorptive coatings such as coatings containing precipitated silica can be applied beneath the coating composition according to the invention. Furthermore, one or more polymer layers (e.g. polyethylene) can be applied to the substrate and/or to the coating according to the invention, to increase the mechanical stability and/or the gloss of the coating (e.g. photographic base paper, lamination).

The carriers may be transparent or opaque. There are no restrictions on the thickness of the carrier, however thicknesses of 50 to 250 μm are preferred.

The invention further provides the production of an ink-absorbing medium, which is characterised in that the coating composition is applied to the carrier and dried. The coating composition can be applied by all of the conventional application processes such as rolling blade application, blade coating, airbrushing, doctor blade (profiled, smooth, split), the cast-coating process, film pressing, bonding-pressing, curtain-coating and slot-die application (for example coating blade) and combinations thereof. Processes are preferred which allow very homogeneous coating, such as e.g. cast-coating, curtain-coating and slot-die application. The coated substrate can be dried by all of the conventional processes such as air- or convection drying (e.g. hot air channel), contact or conduction drying, energy radiation drying (e.g. infra-red and microwave).

A further object of the invention is the use of the aluminium oxide dispersion according to the invention for polishing and cleaning metals, semi-conductor elements in the electronics industry, glass, ceramics and other hard materials.

A further object of the invention is the use of the aluminium oxide dispersion according to the invention for the coating of fluorescent tubes, lightbulbs or other light sources.

### EXAMPLE 1

### Alumina Powder

320 kg/h previously-evaporated aluminium trichloride (AlCl₃) is burned together with 100 Nm³/h hydrogen and 450 Nm³/h air in a burner of known construction.

After the flame reaction, the fine-particle, high-surface-area aluminium oxide is separated from the hydrochloric acid gases that have also formed, in a filter or cyclone, any HCl traces still adhering being then removed by treatment with moistened air at increased temperature.

Alumina powder 2 is isolated. The physical/chemical data are shown in Table 1. Alumina powder 1 and 3 are prepared in the same way by varying the reaction conditions.

TABLE 1
Physical/chemical data of Alumina powder

| | | Alumina | Alumina | Alumina |
|---|---|---|---|---|
| | | Powder 1 | Powder 2 | Powder 3 |
| BET | m²/g | 100 | 129 | 65 |
| Sears number* | ml/2 g | 15.25 | 20.60 | 10.15 |
| Sears number*/ | ml/2 m² | 0.153 | 0.160 | 0.156 |
| BET | | | | |

*pH 4 to 9; the measurement of the Sears number is disclosed in EP-A-717008;

### EXAMPLE 2

### Alumina Dispersion According to the Invention

First, 280 litres de-ionised water are brought to pH 3.9 with a propionic acid in a receiving vessel.

80 kg of alumina powder 2 (equivalent to 20 wt.-% aluminium oxide) are then introduced into the water with a rotor-stator machine. After incorporating the whole quantity of the powder, the suspension obtained is intensively sheared for ca. 60 minutes.

Whilst the powder is being introduced, the pH value is maintained at pH=4.0 to 4.1 by adding 18 litres of semi-concentrated acid. The subsequent shearing process is carried out with the rotor-stator machine at maximum shear energy and lasts for a total of 60 minutes.

After completion of the shearing process, the pH value is 4.1. After adding 2 kg of a biocide, the pH value was brought to the final pH of 3.9 with a further 6 litres of propionic acid. Once production of the dispersion is complete, the liquid volume is increased to 400 litres by adding 14 litres distilled water.

The particle size set after the shearing process is d₅₀=140 nm.

For alumina powder 1 d₅₀=126 nm, for alumina powder 3 d₅₀=110 nm.

### EXAMPLE 3

### Inkjet Coating According to the Invention

An aqueous polyvinyl alcohol solution (Mowiol 40-88, Clariant) with 12.14% solid content, is placed in a 400 ml beaker and a quantity of water is added to it, so that, together with the aluminium oxide dispersions according to example 2, a solid content of 18% is obtained.

The alumina dispersion is slowly dropped into the polyvinyl alcohol solution using a pipette, within 5 minutes, whilst stirring at 500 rpm. Once it has been added, stirring continues for a further 30 minutes at 500 rpm to obtain a homogenous coating composition. The coating compositions are then de-aerated using a dessicator and water-jet pump.

As a control, the actual solid matter, pH value and viscosity are measured after mixing the coating compositions. The parts in Table 2 below are understood to mean parts by weight in relation to the solid matter.

The gloss values are measured with a Byk-Gardner gloss meter using test card 2855 (black spectrum) as a basis.

The printing properties of the coating composition are evaluated by printing out a test image on the coating, using an HP 550 C printer and an Epson Stylus Colour 800 printer respectively and having these printed coatings evaluated by 3 independent persons.

The colour densities are measured on the basis of the test image, which also contains full-area colours (black, magenta, cyan, yellow) using a GretagMacbeth (trademark) SpectroEye at an observation angle of 2° and a D50 light source.

The viscosity data obtained show that the dispersion according to example 2, and the longest dispersion time, produces the lowest viscosities. This is desirable as the solid matter in the coating composition can still be increased without obtaining viscosities that are too high to be applied.

A 100 micron thick, un-treated polyester film is coated using an Erichsen Film Applicator device with a 120 micron wet film spiral applicator. The coating composition applied is dried using a hot air dryer.

Discussion of the Gloss Values:

It can clearly be seen from the gloss values given in Table 3, that the dispersion according to the invention produces higher gloss values in the coating composition after 60 minutes' dispersion time, than the dispersions produced by other methods.

With photo-realistic coatings, a high gloss is desirable, as already disclosed in EP732219. The gloss values are lower than those in EP732219, but this is due to the different processes for the production of the Inkjet medium and not to the coating composition. A spiral applicator is consciously used in this test to determine the contribution of the dispersion in the Inkjet coating to the gloss. With the cast-coating process used in EP732219, the gloss is primarily determined by the process itself.

When using two different types of printer, the coating containing the dispersion with the longest dispersion time, according to example 2, produces the best results.

When examining the colour densities (Table 4), it can be seen that the coating containing the dispersion according to example 2 of the invention, with the longest dispersion time, reproduces the highest colour densities. This is desirable to obtain the most photo-realistic reproduction possible.

The parts in the table below are understood to mean parts by weight in relation to the solid matter.

The viscosity data obtained show that the lowest viscosities are obtained with the dispersion according to example 2 and the longest dispersion time. This is desirable, as the solid matter in the coating composition can be increased still further without obtaining viscosities that are too high for application.

Matt-coated 110 g/m² Inkjet paper (Zweckform no. 2576) is coated using an Erichsen Film Applicator device with a 60 micron wet film spiral applicator. The coating composition applied is dried with a hot air dryer.

The coatings are then calendered three times at 10 bar pressure and 50° C. with a Gradek Oy (Trademark) laboratory calender.

The dispersion according to the invention is eminently suitable for the production of Inkjet coating compositions and their further processing to produce high-gloss printing media, as can be seen from the examples given. The Inkjet media produced in this way have a particularly good print and gloss quality.

Further Inkjet Application Test Results

Based on the particle knowledge, the effects for the make-down of inkjet coating formulation, its coating processing and finally the print results have been studied. Coated sheet is a PET film. For the make-down procedure all pigments are added to the PVA binder solution as dispersions in water. The features tested for a glossy inkjet coating are formulation: binder content, flow properties, indicated as runnability; and sheet and print: gloss (60°), colour quality, resolution.

The binder content is optimised individually for each pigment. It is regarded as minimised as soon as cracking after drying has disappeared. The Brookfield viscosity of the coating formulation is the means to judge its runnability, considering also the respective solid content. The sheets are printed on an Epson Stylus Color 980. Colour is measured with a spectrophotometer. The line sharpness of image analysis gives the resolution and, hence, indirectly the absorption ability of the coating layer.

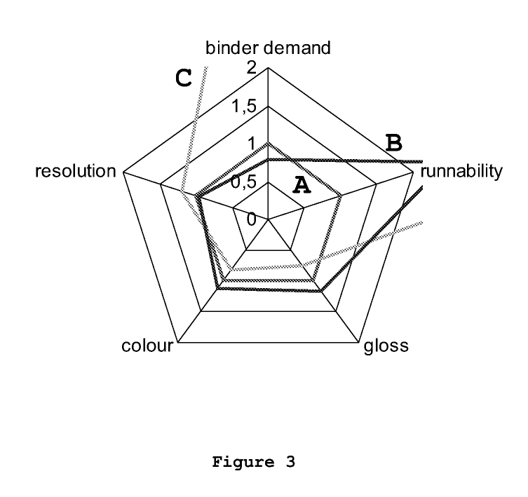

A normalised diagram (FIG. 3; A=coating comprising alumina powder 1 (A), alumina powder 2 (B) and alumina powder 3 (C) shows the performance of a coating composition according to the invention comprising a fumed alumina powder having a BET surface area of 100 m²/g as reference. Values larger than one show advantages compared to the reference and values smaller than one disadvantages.

A dispersion comprising alumina powder 1 reduces dramatically the binder demand and improves strongly the runnability of the formulation during the coating process. It improves also the resolution.

A dispersion comprising the alumina powder 2 on the other hand, improves both gloss and colour quality. Runnability is still much better compared to the reference.

TABLE 2
Coating composition comprising 100 parts of dispersion from example 2 and 20 parts
of polyvinyl alcohol

| | Dispersion time | | |
|---|---|---|---|
| | 15 | 30 | 60 |
| Actual solid content of the | 18.03 | 18.01 | 18.00 |
| coating compositions in % | | | |
| pH value | 4.7 | 4.6 | 4.6 |

Viscosity, Brookfield in mPas after 24 h

| | | | | |
|---|---|---|---|---|
| After stirring | 5 rpm | 920 | 824 | 748 |
| | 10 rpm | 840 | 716 | 664 |
| | 20 rpm | 715 | 608 | 534 |
| | 50 rpm | 560 | 512 | 462 |
| | 100 rpm | 463 | 398 | 346 |

| | | | |
|---|---|---|---|
| Application behaviour | Good | Good | good |
| Avg. application weight in | 26.1 | 25.9 | 26.2 |
| g/m² and standard deviation | s = 0.4 | s = 0.2 | s = 0.3 |
| Adhesion, surface and | Good adhesion | Very good adhesion | Very good adhesion |
| smoothness of the coating | to the film, | to the film, | to the film, |
| | homogeneous | homogeneous | homogeneous |
| | surface | surface | surface |
| Gloss at 20°/ | 24.6 | 26.3 | 28.8 |
| standard deviation at n = 5 | s = 0.4 | s = 0.1 | s = 0.3 |
| Gloss at 60°/ | 46.3 | 49.7 | 54.7 |
| standard deviation at n = 5 | s = 0.2 | s = 0.3 | s = 0.3 |

TABLE 3
Printing test* using coating composition of example 3

| | | Dispersion time | | |
|---|---|---|---|---|
| | | 15 | 30 | 60 |
| | | minutes | minutes | minutes |
| | | Four colour print | | |
| | | Hewlett-Packard 550C | | |
| Colour intensity | Magenta/Yellow/Cyan | 1.25 | 1 | 1 |
| | Black | 1 | 1 | 1 |
| dot sharpness | Black in colour | 1.5 | 1.25 | 1.25 |
| Transitions | Colour to colour | 1 | 1 | 1 |
| | Black to colour | 1.25 | 1 | 1 |
| Contours | | 1 | 1 | 1 |
| Print | | 1.25 | 1.25 | 1 |
| Halftone | | 1 | 1 | 1 |
| Photo quality | | 1.25 | 1.25 | 1 |
| Total evaluation | | 10.5 | 9.75 | 9.25 |
| Average marks | | 1.17 | 1.08 | 1.03 |
| | | Four colour print | | |
| | | Epson Stylus Color 800 | | |
| Colour intensity | Magenta/Yellow/Cyan | 1.25 | 1 | 0.75 |
| | Black | 1 | 1 | 0.75 |
| Dot sharpness | Black in colour | 1.25 | 1 | 1 |
| Transitions | Colour to colour | 1 | 1 | 1 |
| | Black to colour | 1 | 1 | 1 |
| Contours | | 1 | 1 | 1 |
| Print | | 1 | 1 | 1 |
| Halftone | | 1.25 | 1 | 1 |
| Photo quality | | 1 | 1 | 0.75 |
| Total evaluation | | 9.75 | 9 | 8.25 |
| Average mark | | 1.08 | 1.00 | 0.92 |

*Top mark 0.75; Bottom mark 6

TABLE 4
Colour densities

| | Dispersion time | | |
|---|---|---|---|
| | 15 minutes | 30 minutes | 60 minutes |
| HP550 C | | | |
| Paper white | 0 | 0 | 0 |
| Mean black | 2.33 | 2.36 | 2.42 |
| Mean yellow | 1.67 | 1.69 | 1.73 |
| Mean cyan | 2.33 | 2.35 | 2.39 |
| Mean magenta | 1.39 | 1.42 | 1.46 |
| Total | 7.72 | 7.82 | 8 |
| Epson Stylus Color 800 | | | |
| Mean black | 2.89 | 2.96 | 2.98 |
| Mean yellow | 1.92 | 1.97 | 2.04 |
| Mean cyan | 2.96 | 3.03 | 3.09 |
| Mean magenta | 2.13 | 2.25 | 2.31 |
| Total | 9.9 | 10.21 | 10.42 |

1. A dispersion of aluminum oxide, comprising:
20 to 60 wt.% of pyrogenically-produced aluminum oxide powder in the form of aggregates of primary particles, wherein the powder has
a BET specific surface area ranging from 50 to 150 m²/g
a ratio of Sears number/BET surface area which ranges from about 0.150 to 0.160,
wherein the mean aggregate diameter of particles in the dispersion is less than 200 nm.

2. The dispersion according to claim 1, which, in addition to aluminum oxide, inorganic acids, organic acids, inorganic bases, organic bases, salts, buffer systems, ionic or non-ionic surfactants, polyelectrolytes, polymers and/or biocides.

3. A process for the production of the dispersion according to claim 1, wherein the pyrogenically-produced aluminum oxide is mixed with water, a pH value of 2 to 11 of the aqueous medium is set, and the mixture is dispersed by the introduction of controlled shearing forces.

4. The process for the production of the dispersion according to claim 3, wherein the shearing equipment is a rotor-stator machine, a ball mill, a pearl mill, an agitated ball mill or a high-energy shearing processes process.

5. A coating composition, comprising: the dispersion according to claim 1 and at least one binder.

6. The coating composition according to claim 5, wherein the content of alumina particles is 10 to 50 wt. %.

7. The coating composition according to claim 5, wherein the content of binder in relation to the alumina particles is 3 to 150 wt. %,

8. A process for the production of the coating composition according to claim 5, wherein the dispersion is added to an aqueous solution of the binder, to which further additives may optionally be added, whilst stirring, and is optionally diluted until the desired ratio of alumina to binder and the desired solids content is obtained.

9. An ink-absorbing medium, comprising:
the coating composition according to claim 5 and a carrier.

10. The ink-absorbing medium according to claim 9, wherein the coating composition is applied to the carrier and dried.

11-12. (canceled)

13. A method, comprising:
polishing and cleaning metals, semi-conductor elements in the electronics industry, glass, ceramics and other hard materials with the aluminum oxide dispersion according to claim 1.

14. A method, comprising:
coating fluorescent tubes, lightbulbs and other light sources with the aluminum oxide dispersion according to claim 1.
